(19) United States
(12) Patent Application Publication
(10) Pub. No.: US 2016/0041420 A1
(43) Pub. Date: Feb. 11, 2016

(54) DISPLAY APPARATUS

(71) Applicant: Sharp Kabushiki Kaisha, Osaka (JP)

(72) Inventor: Kenji TAKASE, Osaka (JP)

(73) Assignee: Sharp Kabushiki Kaisha, Osaka (JP)

(21) Appl. No.: 14/781,809

(22) PCT Filed: Feb. 27, 2014
(86) PCT No.: PCT/JP2014/054812

§ 371 Date: Oct. 1, 2015

(30) Foreign Application Priority Data
Apr. 4, 2013 (JP) 2013-078611

(51) Int. Cl. G02F 1/1333

(52) U.S. Cl. CPC G02F 1/133308; G02F 2001/133322; G02F 2001/13332

(57) ABSTRACT

Provided is a display device by which the non-display region where images are not displayed is reduced and movement or detachment of components is mitigated by a simple structure, thereby allowing for an increase in reliability. A display device includes: a first cover member including a first frame region surrounding an edge of a front surface of a display unit; a second cover member disposed on a front surface of the first cover member and including a second frame region overlapping the first frame region; engaging grooves formed on the front surface of the first frame region 31; and engaging protrusions that protrude from a rear surface of the second frame region and are slidably inserted into the engaging groove.

### TECHNICAL FIELD

The present invention relates to a display device.

### BACKGROUND ART

A display device such as a liquid crystal display device includes a display unit having the front surface as the display surface, a cabinet having an opening in the front surface and surrounding the periphery of the front surface of the display unit, and a cover disposed on the front surface of the cabinet and covering the periphery of the opening. In the display device, the opening is the display region where images and the like are displayed, and the portion peripheral to the opening is a region where images are not displayed, or in other words, a so-called frame region.

At least one of the cover and the cabinet is made of a resin molded body, and due to variations in the shape thereof, there were cases where attachment was difficult or the structure after attachment was unstable (with wobbling and the like). Japanese Patent Application Laid-Open Publication No. 2008-83562 discloses a display device having a simple structure and by which attachment defects resulting from variations in shape are mitigated.

The display device disclosed in Japanese Patent Application Laid-Open Publication No. 2008-83562 has formed therein a groove including an engaging portion on a surface facing the periphery of the opening or a portion of the cover facing the periphery of the opening, and the other edge portion includes a protrusion that includes an engaged portion engaged with the engaging portion. The protrusion is inserted into the groove and the engaging portion and the engaged portion are engaged to each other, thereby attaching the cover to the cabinet.

In this manner, by the engaging portion being formed on the opposing surface, the engaging portion and the engaged portion reliably engage each other even if there are variations in shape of the cabinet and cover, and thus, the cover does not easily detach from the cabinet.

In recent years, there has been increasing demand for reducing the size of the frame region in display devices, or in other words, narrowing the frame region. By narrowing the frame region, it is possible to reduce the outer size of the display device, to eliminate waste, and to reduce weight.

### RELATED ART DOCUMENT

### Patent Document

Patent Document 1: Japanese Patent Application Laid-Open Publication No. 2008-83562

### SUMMARY OF THE INVENTION

### Problems to be Solved by the Invention

However, the display device disclosed in Japanese Patent Application Laid-Open Publication No. 2008-83562 has the groove formed in the frame region with the protrusion being inserted in the groove, and thus, if the frame is narrowed, this reduces the distance between the edge and the cabinet or the cover where the groove is formed, which poses the risk that sufficient fixing strength cannot be attained.

Also, if the frame region of the display device of Japanese Patent Application Laid-Open Publication No. 2008-83562 is reduced, then the positioning of the groove and the protrusion must be highly accurate, and this requires extra time and effort in manufacturing the cabinet and the cover.

An object of the present invention is to provide a display device by which the non-display region where images are not displayed is reduced in size and movement or detachment of components is mitigated by a simple structure, thereby allowing for an increase in reliability.

### Means for Solving the Problems

In order to achieve the above-mentioned object, the present invention provides a display device including: a first cover member including a first frame region that surrounds a periphery of a front surface of a display unit; a second cover member disposed on a front surface of the first cover member and including a second frame region that coincides in position with the first frame region; an engaging protrusion that protrudes from one of a front surface of the first frame region or a rear surface of the second frame region; and an engaging groove formed in a surface opposing whichever of the front surface of the first frame region or the rear surface of the second frame region has the engaging protrusion protruding therefrom, the engaging protrusion being slidable in the engaging groove, wherein the engaging protrusion is inserted from an end of the engaging groove and slid inside the engaging groove, thereby positioning the second cover member in relation to the first cover member.

According to this configuration, the engaging protrusion and the engaging groove are formed in portions where the first cover member and the second cover member overlap, or in other words, portions that cannot be seen by a viewer. By inserting the engaging protrusion into the engaging groove from the end thereof and sliding the engaging protrusion in the engaging groove, the first cover member and the second cover member are assembled together. Thus, compared to a conventional display device in which the second cover member is formed on the outside of the first cover member or so as to be opposite thereto, it is possible to reduce the size of the portion outside the display region (the so-called frame region). Also, by sliding the engaging protrusion in the engaging groove, it is possible to position the second cover member, and thus assembly is simple.

In this manner, it is possible to dispose the display device having a large display region in a small space (which improves flexibility in selecting where to place the display device), and it is possible to reduce unneeded portions of the frame region, which is effective for reducing the size and weight of the display device.

In the configuration above, the engaging protrusion and the engaging groove may have detachment prevention structures that, when a force in a direction away from the first cover member acts on the second cover member, contact each other to prevent detachment of the second cover member from the first cover member.

In the configuration above, the detachment prevention structures may include: a retaining portion disposed on a tip of the engaging protrusion and formed so as to extend in a direction intersecting with a direction in which the engaging protrusion slides; and a retaining groove provided inside the engaging groove and extending in a direction intersecting with a lengthwise direction of the engaging groove, the retaining groove being formed in a shape allowing slidable insertion therein of the retaining portion of the engaging protrusion. Engaging protrusions and engaging grooves having such a configuration can have a T shape in a cross-sectional view or an L shape in a cross-sectional view, for example.

In the configuration above, the detachment mitigation structures may include: an inclined surface provided on the engaging protrusion and inclined in relation to a line normal to a protruding surface of the engaging protrusion; and an inclined surface provided in the engaging groove and formed so as to face the inclined surface of the engaging protrusion. Examples of engaging protrusions and engaging grooves having such a configuration include those with a trapezoidal shape in a cross-sectional view in which the engaging protrusions and the engaging grooves are formed so as to be inclined with respect to a line normal to the contact surface between the first cover member and the second cover member.

In the configuration above, the first frame region and the second frame region may be rectangular frames including a pair of longer sides and a pair of shorter sides, and the engaging groove may be formed in either the pair of longer sides or the pair of shorter sides of the first frame region or the second frame region.

In the configuration above, the first cover member may be a bezel for holding in place the display unit and the second cover member may be a lens cover including a lens portion in side edges of the second cover member. By using such a lens cover, it is possible to make the first frame region of the first cover member impossible or difficult to see from the front of the display device. If the engaging protrusion is provided on the lens cover in particular, then the engaging protrusion is not inserted in the lens cover, and thus, it is possible for the thin lens cover to prevent the first frame region described above from being seen.

### Effects of the Invention

According to the present invention, it is possible to provide a display device by which the non-display region where images are not displayed is reduced in size and movement or detachment of components is mitigated by a simple structure, thereby allowing for an increase in reliability.

### BRIEF DESCRIPTION OF THE DRAWINGS

FIG. 1 is an exploded perspective view of one example of a display device according to the present invention.

FIG. 2 is a front view of a cabinet used in the display device of the present invention.

FIG. 3 is a rear view of a cover used in the display device of the present invention.

FIG. 4 is an expanded cross-sectional view of a state in which the cover is removed from the display device of the present invention.

FIG. 5 is an expanded perspective view showing a state in which the cover is attached to the cabinet.

FIG. 6 is a rear view of a cover used in another example of the display device of the present invention.

FIG. 7 is an expanded cross-sectional view of a state in which the cover is removed from another example of the display device of the present invention.

FIG. 8 is an expanded cross-sectional view of a state in which the cover is removed from yet another example of the display device of the present invention.

FIG. 9 is an expanded cross-sectional view of a modification example of the display device shown in FIG. 8.

FIG. 10 is a side cross-sectional view of a state in which the cover is removed from yet another example of the display device of the present invention.

FIG. 11 is a front view of a cabinet used in yet another example of the display device of the present invention.

FIG. 12 is a rear view of a cover used in yet another example of the display device of the present invention.

FIG. 13 is a side cross-sectional view of a state in which the cover is removed from yet another example of the display device of the present invention.

### DETAILED DESCRIPTION OF EMBODIMENTS

### Embodiment 1

Embodiments of the present invention will be explained below with reference to the drawings.

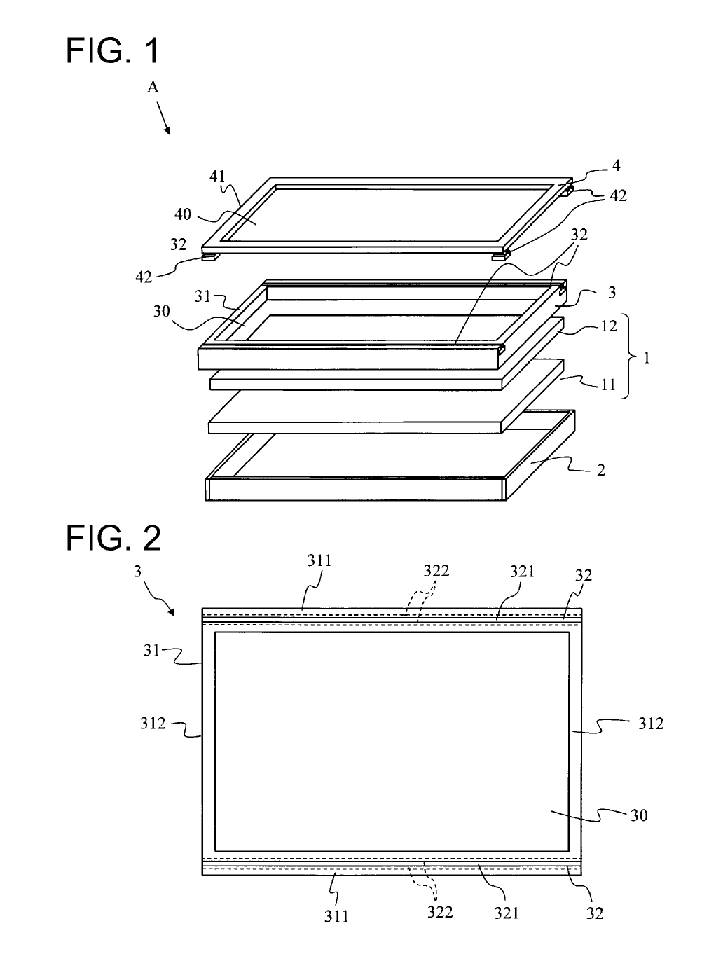

FIG. 1 is an exploded perspective view of one example of a display device according to the present invention. As shown in FIG. 1, a display device A includes a display unit 1 that displays images, a chassis 2 that covers the rear surface of the display unit 1 (display portion), a cabinet 3 (first cover member) that covers the edges of the front surface of the display unit 1, and a cover 4 (second cover member) disposed to the front of the cabinet 3.

The display unit 1 has a rectangular shape as seen from the front and includes a display surface that displays images on the front surface. The display unit 1 includes a backlight 11 that emits planar light towards the front, and a liquid crystal panel 12 disposed to the front of the backlight 11.

The backlight 11 is of an edge-lit type including a light source, a light guide plate, and optical sheets (none shown). The backlight 11 is attached to the chassis 2. The backlight 11 is not limited to this configuration, and a direct lit backlight in which light sources are arranged opposite the liquid crystal panel or EL backlights are sometimes used, but even in these cases, the backlight is attached to the chassis 2, similarly to the edge lit backlight. The liquid crystal panel 12 has a display surface in which images are displayed on the front surface, and when the planar light from the backlight 11 passes therethrough, the proportion of light passing therethrough is adjusted, thereby displaying images on the display surface.

The display unit 1 here is a display device constituted by a combination of the backlight 11 and the liquid crystal panel 12, but the configuration is not limited thereto, and a self-luminous display device such as an EL (organic EL) panel can be used, for example.

The chassis 2 is a shallow box-shaped member formed by bending a metal plate, and is disposed so as to cover the rear surface of the display unit 1. The cabinet 3 is disposed to the front of the display unit 1 and is a member that presses the edges of the display unit 1. The cabinet 3 is a frame-shaped member that includes an opening window 30, which is a rectangular penetrating hole in the central portion.

The rear surface of the display unit 1 is pressed by the chassis 2 and the front edges of the display unit 1 are pressed by the cabinet 3, thus supporting the display unit 1 by the chassis 2 and the cabinet 3. The cover 4 is used as an external case to the front of the display device A. The cover 4 includes an opening window 40 in the central portion thereof, similar to the cabinet 3. Below, details of the cabinet 3 and the cover 4 and the attachment method thereof will be described with reference to the drawings. In the description below, the same display unit 1 and chassis 2 of the display device are used, and thus, details thereof are omitted.

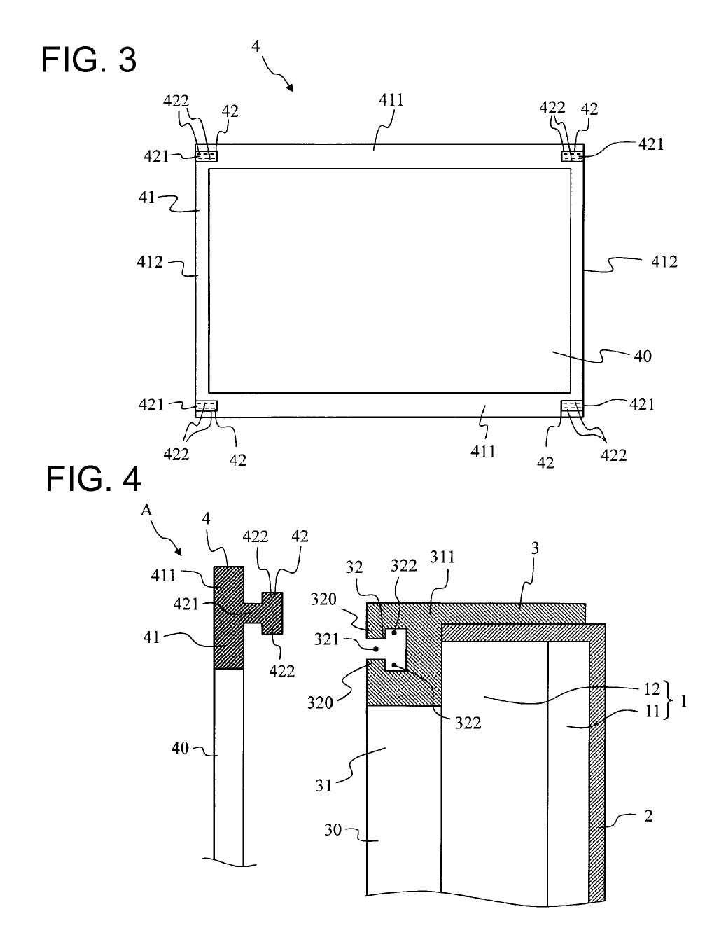

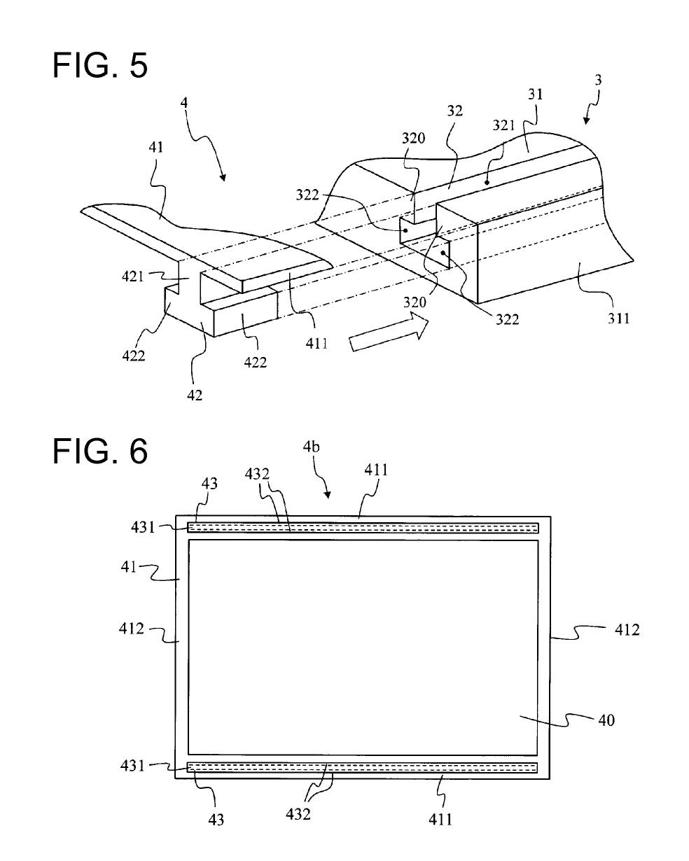

Details of the display device according to the present invention will be explained below with reference to the drawings. FIG. 2 is a front view of a cabinet used in the display device of the present invention, FIG. 3 is a rear view of a cover used in the display device of the present invention, FIG. 4 is an expanded cross-sectional view of a state in which the cover is removed from the display device of the present invention, and FIG. 5 is an expanded perspective view showing a state in which the cover is attached to the cabinet. The up/down direction in FIGS. 2 to 5 matches that of the display device A when arranged in position. In the description below, “up” and “down” are defined with reference to FIG. 2.

Here, the cabinet 3 is an integrally molded resin body. The cabinet 3 presses the front edges of the display unit 1, and has a frame shape covering the side faces of the display unit 1 (side faces of the chassis 2, the display unit 1 being provided to the inside thereof). The cabinet 3 includes a main body portion 31 (first frame region) including longer sides 311 and shorter sides 312 surrounding the opening window 30, and engaging grooves 32 extending along the upper and lower sides (here, the longer sides 311) when the display device A is arranged in position. The engaging grooves 32 formed in the front surface of the cabinet 3 are formed along the lengthwise direction of the cabinet 3 (along the longer sides 311) to the same length as the longer sides 311, and the end of the engaging grooves 32 passes through the shorter sides 312.

The engaging grooves 32 have a shape by which it is possible to slidably engage with engaging protrusions 42 of the cover 4 to be described later. A detailed explanation of the engaging grooves 32 will be given later.

Here, the cover 4 is an integrally molded resin body. The cover 4 has a plate shape with an opening in the central portion thereof. As shown in FIG. 3, the cover 4 includes a main body portion 41 (second frame region) including longer sides 411 and shorter sides 412 surrounding an opening window 40, and engaging protrusions 42, which are protrusions formed on the rear surfaces of the longer sides 411. The engaging protrusions 42 can be slid into the engaging grooves 32 formed in the cabinet 3, and the engaging protrusions 42 are formed such that when disposing the cover 4 on the front surface of the cabinet 3 so as to coincide therewith, the engaging protrusions 42 engage the engaging grooves 32. As shown in FIG. 3, the engaging protrusions 42 have a shape extending along the longer sides 411, and are provided at the four corners of the cover 4.

As shown in FIGS. 1 and 4, the cover 4 is attached to the front surface of the cabinet 3 so as to coincide therewith in a front view. The opening window 30 of the cabinet 3 and the opening window 40 of the cover 4 constitute a window portion (display region) through which the image display surface of the display unit 1 can be seen. Thus, when arranging the cabinet 3 and the cover 4 so as to coincide in position, the centers of the opening window 30 and the opening window 40 coincide. At this time, it is preferable that the main body portion 31 of the cabinet 3 not be seen. Thus, it is preferable that the opening window 30 be the same size as or slightly larger than the opening window 40. In the present invention, the opening window 30 and the opening window 40 have the same shape and size as seen from the front.

The cabinet 3 covers the edges of the front surface of the display unit 1, and also covers side faces of the chassis 2 on which the display unit 1 is disposed. The chassis 2 is fixed to the cabinet 3 by a well-known conventional method, and thus, details thereof are omitted. In other words, the display unit 1 and the chassis 2 are fixed to the rear surface of the cabinet 3. The cover 4 is attached to the front surface of the cabinet 3, and the display unit 1 and the chassis 2 are fixed to the rear surface of the cabinet 3. At this time, the engaging protrusions 42 of the cover 4 are inserted from the lengthwise direction ends of the engaging grooves 32 of the cabinet 3, and the cover 4 is slid onto the cabinet 3 and attached thereto.

The engaging grooves 32 of the cabinet 3 and the engaging protrusions 42 of the cover 4, which are main parts of the present invention, will be described in detail. As shown in FIG. 2 and the like, the engaging grooves 32 are formed on the pair of longer sides 311 of the cabinet 3. The engaging grooves 32 each include an opening 321 extending in the lengthwise direction of the front surface side thereof, and also include retaining grooves 322 having inner portions shaped so as to have bends in a direction perpendicular to the lengthwise direction of the engaging grooves 32. In other words, the engaging grooves 32 include a pair of ribs 320, and the space between the tips of the ribs 320 is the opening 321 (see FIG. 4).

As shown in FIGS. 4 and 5, the retaining grooves 322 are provided on both sides of the opening 321 of the engaging groove 32. In other words, the engaging groove 32 has a T shape in a cross-sectional view along the line perpendicular to the longer sides of the cabinet 3. The engaging grooves 32 are not limited to such a shape, and a configuration allowing the engaging protrusions 42 not to detach towards the front when engaged with the engaging grooves 32 can be widely used.

As shown in FIGS. 4 and 5, the engaging protrusions 42 of the cover 4 include projections 421 that protrude integrally from the rear of the longer sides 411, and retaining portions 422 that extend from the tip of the projections 421 in a direction intersecting with (perpendicular to) the sliding direction of the engaging protrusions 42. As described above, the engaging protrusions 42 are disposed so as to be able to slide in the engaging grooves 32. In other words, the engaging protrusions 42 have a T shape in a cross-sectional view. As shown in FIGS. 3 and 5 and the like, the projections 421 of the engaging protrusions 42 have a rectangular cuboid (or cube) shape extending in the lengthwise direction of the longer sides 411 of the cover 4. The retaining portions 422 are members having a rectangular (or square) plate shape in a front view. In the engaging protrusions 42, the projections 421 and the retaining portions 422 are formed integrally. The engaging protrusions 42 are formed integrally with the cover portion 4.

Next, the method of attaching the cover 4 to the cabinet 3 will be described with reference to the drawings. As shown in FIG. 2, in the display device A, both lengthwise direction ends of the engaging groove 32 formed on the cabinet 3 are open on the side portions of the shorter sides 312 of the cabinet 3. The cover 4 is attached to the cabinet 3 by inserting the engaging protrusions 42 provided on both edges (up and down) of one shorter side 412 through the open portions of the engaging grooves 32. FIG. 5 shows a configuration in which the engaging protrusion 42 provided on the right side as seen from the front of the cover 4 is inserted from the left end open portion as seen from the front of the engaging groove 32 formed on the longer side 311 on the lower portion of the cabinet 3.

As shown in FIG. 5, the engaging protrusion 42 is inserted into the engaging groove 32 such that the projection 421 of the engaging protrusion 42 is inserted in the opening 321 and the retaining portion 422 is inserted into the retaining groove 322. By sliding the cover 4 in the lengthwise direction of the engaging groove 32 of the cabinet 3, the cover 4 is disposed to the front of the cabinet 3. The engaging protrusion 42 is also formed on the rear ends (up and down) of the shorter sides in the sliding direction of the cover 4, and after sliding in the cover 4, this engaging protrusion 42 is also inserted into the open portion of the end of the engaging groove 32. The cover 4 and the cabinet 3 are then fixed to each other. At this time, the retaining grooves 322 of the engaging grooves 32 and the retaining portions 422 of the engaging protrusions 42 are prevented from detaching from each other by being in contact with each other, and thus, the retaining grooves 322 and the retaining portions 422 form a structure that mitigates detachment.

The display device A is normally used in a state in which the cabinet 3 is stood up such that the longer sides are horizontal. The engaging grooves 32 of the cabinet 3 are formed on the upper and lower longer sides 311 and extend in the horizontal direction, and thus, even if the weight of the cover 4 causes a force to act on the cover 4 to pull it downward in a direction along the cabinet 3, the engaging protrusions 42 are pressed against the engaging grooves 32, mitigating slippage of the cover 4. Also, even if a force acts on the cover 4 to cause the upper portion of the cover 4 to rotate about the bottom longer side 411 to the front, detachment of the engaging groove 42 from the engaging groove 32 is mitigated by the retaining portion 422 of the engaging protrusion 42 being in contact with the retaining groove 322 of the engaging groove 32. In this manner, detachment of the cover 4 from the cabinet 3 is mitigated.

The display device A has a configuration in which the engaging grooves 32 are formed on the front surface of the cabinet 3 and the engaging protrusions 42, which protrude from the rear surface of the cover 4, are inserted and slid into the engaging grooves 32, thereby attaching the cover 4 to the cabinet 3. In other words, the engaging portions including the engaging grooves 32 and the engaging protrusions 42 are formed in portions where the cabinet 3 and the cover 4 overlap, and thus, even if the widths of the longer sides 311 and shorter sides 312 of the cabinet 3 and the longer sides 411 and the shorter sides 412 of the cover 4 are made narrow as seen from the front, the configuration is not susceptible to problems relating to strength (deformations and damage). In this manner, in the display device A, it is possible to make regions other than the display region, that is, the so-called frame region small without changing the size of the display region (opening).

In this manner, after the engaging protrusions 42 of the cover 4 are inserted into the engaging grooves 32 of the cabinet 3, the cover 4 is slid across the cabinet 3, thereby allowing the opening window 30 of the cabinet 3 to coincide in position with the opening window 40 of the cover 4 with a high degree of precision. In this manner, it is possible to provide a highly reliable display device with a simple configuration and assembly method.

By using the display device A having such a configuration, it is possible to reduce the size of the frame region, which is a portion of the display device A that does not contribute to image display, and thus, it is possible to reduce excess material and weight. The engaging protrusions and engaging grooves of the present embodiment include a detachment mitigation structure to mitigate detachment, but if the cover is fixed to the cabinet so as to prevent detachment, then such a detachment mitigation structure can be omitted.

The engaging protrusions 42 are provided on both ends of the pair of longer sides 411 of the cover 4. In other words, one engaging protrusion 42 is provided for each of the four corners of the cover 4, forming a total of four. In this manner, even if there is a gap (looseness) between the engaging groove 32 and the engaging protrusion 42, both ends of the longer sides 411 are positioned, and thus, the effect of the looseness can be reduced.

Also, in the display device A, both ends of the engaging grooves 32 of the cabinet 3 are open. The engaging protrusions 42 of the cover 4 are slidably supported in the engaging grooves 32. Thus, by providing a configuration in which the engaging protrusions 42 are stopped by friction while remaining slidable against the engaging grooves 32, it is possible to mitigate unwanted movement (offset) of the cover 4. In the case of a configuration in which the engaging protrusions 42 are stopped from moving in relation to the engaging grooves 32 by friction, the portions of the engaging protrusions 42 and the engaging grooves 32 in contact with each other form a detachment mitigation structure, and thus, the retaining portions and the retaining grooves may be omitted.

Besides this, a configuration may be adopted in which, after the cover 4 is arranged in a precise position to the front of the cabinet 3, a stopper member is inserted from the open portions of both ends of the engaging grooves 32 so as to be in contact with the engaging protrusions 42, thereby preventing the sliding of the engaging protrusions 42, or in other words, the sliding of the cover 4 (the cover 4 is held still). Also, a configuration may be adopted in which only one of both ends of the engaging grooves 32 is open with the other end being closed off. At this time, the cover 4 may be positioned with respect to the cabinet 3 by causing the other end to be in contact with the engaging protrusions 42.

Also, a configuration may be adopted in which some of the four engaging protrusions 42 to be inserted later are formed to be larger than the other engaging protrusions 42 so as to be press fit into the engaging grooves 32, the press fitting of the engaging protrusion 42 stopping the sliding of the engaging protrusions 42 with respect to the engaging grooves 32, or in other words, the sliding of the cover 4 with respect to the cabinet 3. When adopting such a configuration of press fitting, a tapered shape may be adopted in which the end to be inserted is narrow.

Also, similar effects can be attained even if the engaging protrusions 42 provided on both ends of the longer sides 411 are formed so as to be offset (the axes being offset) in a direction intersecting with a line traced along the longer sides 411. By having the amount that the engaging protrusions 42 provided on both ends are offset be equal to or slightly greater than the gap between the engaging grooves 32 and the engaging protrusions 42, it is possible to reduce the difficulty of attaching the cover 4 to the cabinet 3 (difficulty in sliding) while mitigating the effect of rattling between the engaging grooves 32 and the engaging protrusions 42.

The method of preventing sliding of the cover 4 in a direction along the engaging grooves 32 shown here is one example, and other methods may be used.

Also, an example was shown in which a rectangular cuboid (or cube) shape is used for the projections 421 of the engaging protrusions 42 other than the engaging protrusions 42 that stop sliding by being press fit, but the shape is not limited thereto; a shape that allows sliding within the retaining grooves 322 of the engaging grooves 32 such as a cylindrical shape may be used. A configuration allowing sliding within the openings 311 can be widely adopted for the projections 421.

The retaining portions 422 are shown to have a planar form with a rectangular (or square) shape as seen from the front, but the shape is not limited thereto, and may be circular as seen from the front (saucer shape) or may have a three-dimensional shape such as being spherical. A shape preventing the retaining portions 422 from being detached from the ribs 320 can be widely used.

In the display device A, an example is described in which the engaging protrusions 42 are provided on the four corners of the cover 4, but the configuration is not limited thereto. For example, a configuration may be adopted in which the engaging protrusions 42 are formed on both ends of one longer side 411 and in the center of the other longer side 411. A number of engaging protrusions 42 allowing at least one engaging protrusion 42 to be provided on each longer side, and allowing the cover 4 to be accurately and stably attached to the cabinet 3 can be widely adopted.

### Embodiment 2

Another example of a display device according to the present invention will be explained below with reference to the drawings. FIG. 6 is a rear view of a cover used in another example of the display device of the present invention. A cover 4b shown in FIG. 6 has the same configuration as the cover 4 shown in FIG. 3 other than engaging protrusions 43 differing, and parts that are substantially the same are assigned the same reference characters with detailed descriptions thereof being omitted.

As shown in FIG. 6, the engaging protrusions 43 of the cover 4 are provided on the rear surfaces of both of the pair of longer sides 411 of the cover 4. The engaging protrusions 43 have a long shape along the longer sides 411 of the cover 4. As shown in FIG. 6, in the cover 4b, the engaging protrusions 43 are shorter than the longer sides 411, but the configuration is not limited thereto, and the length may be the same (or substantially the same) as that of the longer sides 411.

The engaging protrusions 43 have the same cross-sectional shape as the engaging protrusions 42 of the cover 4. In other words, although the length differs, the engaging protrusions 43 each have a T shape in a cross-sectional view including a projection 431 and a retaining portion 432 provided on the tip of the projection 431. The cabinet 3 has the same configuration, and the engaging grooves 32 of the cabinet 3 have a shape allowing the engaging protrusions 43 to be slid and inserted therein.

By having such engaging protrusions 43, the contact area between the engaging protrusions 43 and the engaging grooves 32 is made to be greater. Thus, a force acting on the engaging grooves 32 and the engaging protrusions 43, which occurs when supporting the cover 4b by the cabinet 3 or when a force to cause the cover 4b to move acts on the cover 4b, is dissipated. In this manner, it is possible to increase strength and to reduce the cross-sectional shape (area) of the engaging grooves 32 and the engaging grooves 43, and it is possible to reduce the size of the frame region, which does not contribute to image display in the display device.

As long as a configuration to firmly hold in place the cover 4b is used, the engaging protrusions 43 may be formed only on one longer side 411 of the cover 4b. The engaging protrusion 42 shown in Embodiment 1 may be formed on the other longer side 411.

Other characteristics are the same as those of the display device of Embodiment 1.

### Embodiment 3

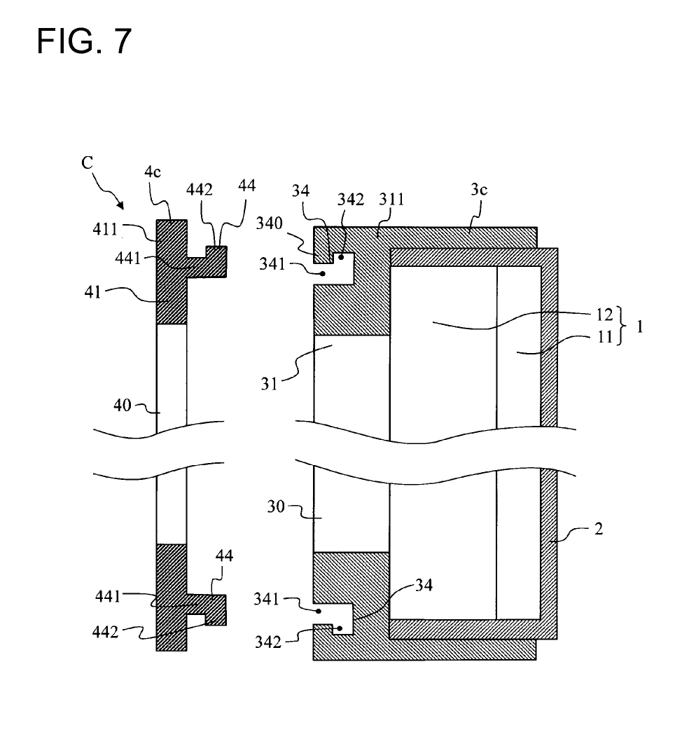

Another example of a display device according to the present invention will be explained below with reference to the drawings. FIG. 7 is an expanded cross-sectional view of a state in which the cover is removed from another example of the display device of the present invention. As shown in FIG. 7, in a display device C, the same configuration is adopted as for the cabinet 3 and the cover 4 of the display device A, other than that engaging grooves 34 of a cabinet 3c and engaging protrusions 44 of a cover 4c differ, and portions that are substantially the same are assigned the same reference characters with detailed descriptions thereof being omitted.

As shown in FIG. 7, the engaging grooves 34 of the cabinet 3c include an opening 341 and a retaining groove 342 having a shape, in the interior portion thereof, with a bend in one direction perpendicular to the lengthwise direction of the engaging groove 34. As shown in FIG. 7, the engaging groove 34 has an L shape in a cross-sectional view taken along a direction perpendicular to the longer side 311 of the cabinet 3c.

As shown in FIG. 7, the engaging protrusions 44 of the cover 4c include projections 441 that protrude from the rear surface of both ends of the longer sides 411 of the cover 4c, and retaining portions 442 that extend from the tip of the projections 441 in one direction intersecting with the lengthwise direction of the projections 441. The engaging protrusions 44 have a shape allowing it to be inserted into the engaging grooves 34. If the retaining groove 342 of the engaging groove 34 is bent towards the outside of the cabinet 3c, for example, then the retaining portion 442 of the engaging protrusion 44 is also bent towards the outside of the cover 4c.

By providing the cabinet 3c and the cover 4c with such a configuration, it is possible to attach accurately and firmly the cover 4c of the display device C to the cabinet 3c. Also, because the engaging grooves 34 and the engaging protrusions 44 have an L shape in a cross-sectional view, the size of the retaining groove 342 of the engaging groove 34 as seen from the front and the size of the retaining portion 442 of the engaging protrusion 44 as seen from the rear (or as seen from the front) are smaller. In this manner, in the display device C, it is possible to make regions other than the display region, that is, the so-called frame region, small without changing the size of the display region (opening).

If engaging grooves 34 and engaging protrusions 44 having an L shape in a cross-sectional view are provided in the pair of longer sides 311 of the cabinet 3c and the pair of longer sides 411 of the cover 4c, then bend portions 342 and the retaining portions 442 may respectively be formed in the same direction or in different directions in the display device C.

Also, the cover 4c and the cabinet 3 may be combined. In other words, a configuration may be adopted in which the engaging protrusions 44 of the cover 4c have an L shape in a cross-sectional view and the engaging grooves 32 of the cabinet 3 have a T shape in a cross-sectional view. In such a case, the retaining portions 442 of the engaging grooves 44 provided on both ends of the longer sides of the cover 4c may be formed in the same direction in the display device C or in different directions.

Other characteristics are the same as those of the display device of Embodiment 1 or Embodiment 2.

### Embodiment 4

Another example of a display device according to the present invention will be explained below with reference to the drawings. FIG. 8 is an expanded cross-sectional view of a state in which the cover is removed from yet another example of the display device of the present invention. In a display device D shown in FIG. 8, a cabinet 3d includes engaging grooves 35 and a cover 4d includes engaging protrusions 45. The engaging groove 35 has a trapezoidal shape in a cross-sectional view having an inclined surface 352 that becomes wider the further away it is from the opening 351; that is, the deeper portions are wider. Also, the engaging protrusion 45 has a trapezoidal shape in a cross-sectional view having an inclined surface 452 that becomes wider the further away it is from the rear surface of the cover 4d; that is, the tip is wider.

In other words, the engaging grooves 35 are formed such that the opening and the retaining groove are shared. Also, the engaging protrusions 45 are formed such that the projection and the retaining portion are shared. By adopting such a configuration, the shape of the engaging groove 35 and the engaging groove 45 are simple, thereby improving ease of manufacturing.

### Modification Example

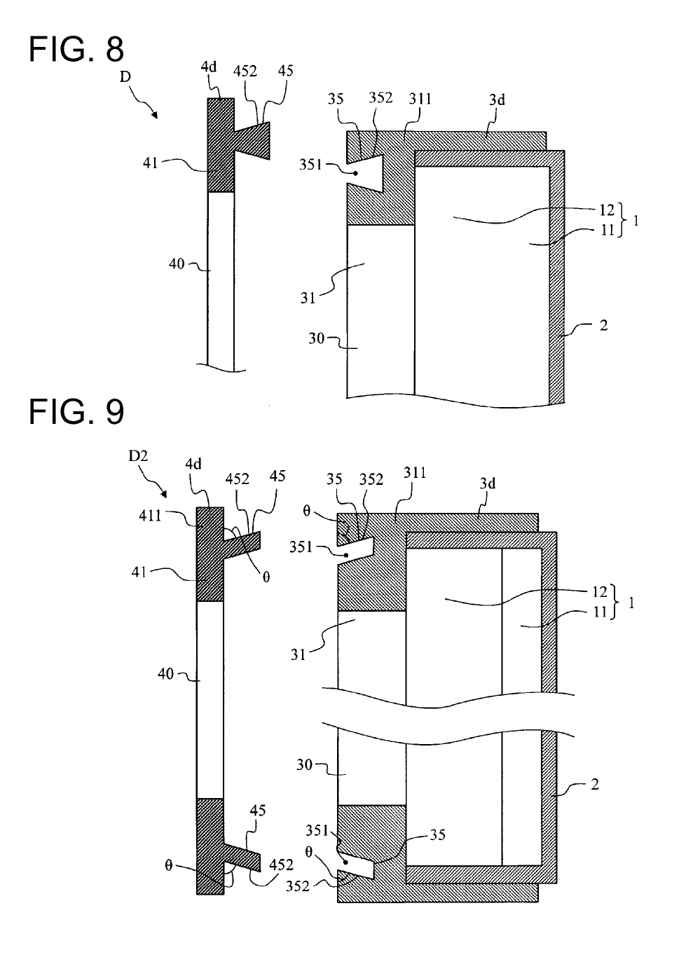

FIG. 9 is an expanded cross-sectional view of a modification example of the display device shown in FIG. 8. A display device D2 shown in FIG. 9 is a modification example of the display device D shown in FIG. 8, and thus, the same reference characters are used. As shown in FIG. 9, the engaging protrusion 45 of the cover 4d is a plate-shaped member having an inclined surface 452 that inclines outward at an angle of inclination θ to the rear surface of the cover 4d. The engaging groove 35 of the cabinet 3d has an inclined surface 352 that faces outward the further away it is from the opening 351. The engaging groove 35 is formed so as to allow sliding of the engaging protrusion 45.

Also, in the display device D2 shown in FIG. 9, the engaging protrusions 45 respectively formed on the pair of longer sides 411 are inclined in differing directions relative to the display device D2. By being inclined in different directions in this manner, even if a force towards a direction away from the cabinet 3d acts on the cover 4d along a direction along one of the engaging protrusions 45, this differs from the direction in which the other engaging groove 45 extends, and thus, it is possible to mitigate the detachment of the cover 4d or the tilting thereof. The shape of the engaging protrusions and the engaging grooves are simple, and thus, manufacturing of the engaging protrusions and engaging grooves is easy, and assembly is also easy.

Other characteristics are the same as those of the display device of Embodiments 1 to 3.

### Embodiment 5

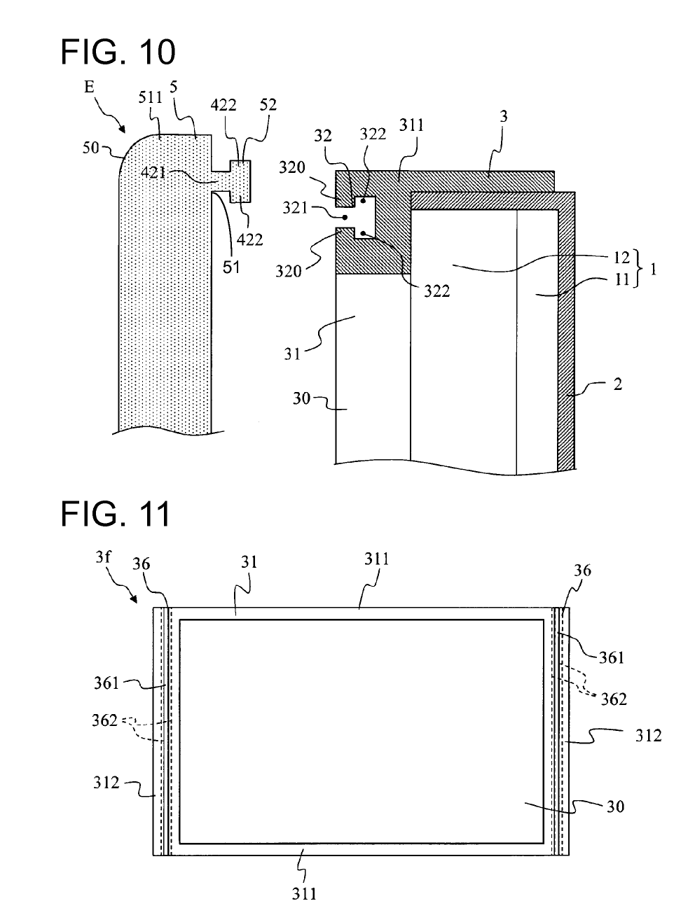

Another example of a display device according to the present invention will be explained below with reference to the drawings. FIG. 10 is a side cross-sectional view of a state in which the cover is removed from yet another example of the display device of the present invention. A display device E shown in FIG. 10 has the same configuration as the display device A other than a differing configuration for a cover 5. Thus, portions of the display device E shown in FIG. 10 that are the same as those of the display device A are assigned the same reference characters and detailed descriptions thereof are omitted.

As shown in FIG. 10, in the display device E, the cover 5 is attached to the front surface of the cabinet 3. The cover 5 is a transparent plate-shaped member and has a configuration in which a lens portion 50 is provided in edge portions.

In a display device G, light emitted from the display surface of the display unit 1 is diffused (spreading) light. This spreading light enters the cover 5 through the opening window 30 of the cabinet 3. The lens portion 50 of the cover 5 causes light emitted from the edge faces of the opening window 30 to be refracted towards the front. By such refraction, the lens portion 50 of the cover 5 can make the main body portion of the cabinet 3 disposed to the rear thereof not visible or not easily visible.

Thus, the cover 5 includes a lens portion 50 formed in the edge portion, a frame-shaped attachment portion 51 formed to the rear of the lens portion 50, and engaging protrusions 52 provided on the longer sides 511 of the attachment portion 51.

The engaging protrusion 52 has the same shape as the engaging protrusion 32 formed on the cover 4 of the display device A. Like the engaging protrusion 32, the engaging protrusion 52 is provided on both ends of the longer sides 511 of the cover 5. The engaging protrusions 52 are inserted into the engaging grooves 32 of the cabinet 3 through the open portions on the ends of the engaging grooves 32 and the engaging protrusions 52 are slid into the engaging grooves 32, thereby enabling the cover 5 to be arranged in position accurately relative to the cabinet 3. The fixing of the cabinet 3 to the cover 5 is the same as the display device A, and thus, descriptions thereof are omitted.

By using the cover 5 having such a configuration, regions other than the display region, that is, the frame region, is not visible (or difficult to see) when viewing the display device E from the front. In this manner, it is possible to improve the design of the display device E. Also, the engaging protrusions 52 protruding from the rear of the cover 5 are inserted into and engage the engaging grooves 32 of the cabinet 3, and thus, even if the frame region is small, the cover 5 can be firmly and stably attached to the cabinet 3. In this manner, the lens portion 50 having the effect of preventing the frame region from being seen can be made small, and it is possible to reduce the size of the cover 5, or even to make the display device E smaller and thinner.

Other characteristics are the same as those of the display device of Embodiments 1 to 4.

### Embodiment 6

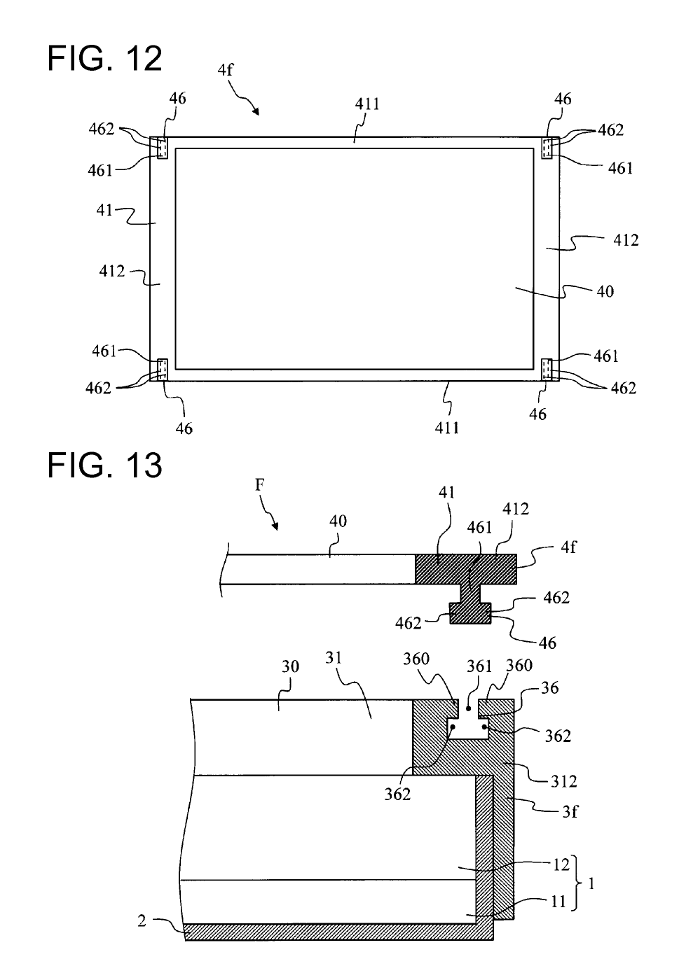

Another example of a display device according to the present invention will be explained below with reference to the drawings. FIG. 11 is a front view of a cabinet used in yet another example of the display device of the present invention, FIG. 12 is a rear view of a cover used in yet another example of the display device of the present invention, and FIG. 13 is a side cross-sectional view of a state in which the cover is removed from yet another example of the display device of the present invention. FIG. 13 shows a state in which the cover has been removed as seen from above.

As shown in FIG. 11, in a display device F of the present embodiment, engaging grooves 36 are formed in the front surface of shorter sides 312 of a cabinet 3f, along the shorter sides 312. Similarly, as shown in FIG. 12, the engaging protrusions 46 are also provided on both ends (up and down in FIG. 12) of the rear surface of shorter sides 412 of a cover 4f. In other portions, the cabinet 3f has the same configuration as the cabinet 3 and the cover 4f has the same configuration as the cover 4, and thus, portions that are substantially the same are assigned the same reference characters with descriptions thereof being omitted.

As shown in FIG. 13, the engaging grooves 36 have the same cross-sectional shape as the engaging grooves 32 in a direction perpendicular to the lengthwise direction of the engaging grooves 36. In other words, the engaging groove 36 has a T shape in a cross-sectional view, including an opening 361 towards the front of the cabinet 3f, and a retaining groove 362 formed to the rear of the opening 361 and extending in a direction intersecting with the lengthwise direction of the opening 361. The engaging protrusions 46 similarly have a T shape in a cross-sectional view allowing them to be slidably inserted into the engaging grooves 36, the engaging protrusions 46 each including a projection 461 protruding from the cover 4f, and a retaining portion 462 extending from the tip of the projection 461 in the lengthwise direction thereof, or in other words, in a direction intersecting with (perpendicular to) the sliding direction of the cover 4f.

Also, as shown in FIG. 11, both ends of the engaging groove 36 are open at the longer sides 311. As shown in FIGS. 12 and 13, the projection 461 of the engaging protrusion 46 has a rectangular cuboid shape extending in a direction along the shorter side 412.

The method of attaching the cover 4f to the cabinet 3f is similar to the method of attaching the cover 4 to the cabinet 3 in the display device A. In other words, the engaging protrusions 46 are inserted to one end (lower end in this case) of both shorter sides 412 from the open portion of the end (upper end in this case) of the engaging groove 36, and the engaging protrusions 46 are slid into the engaging grooves 36. In this manner, the cover 4f is slid across the cabinet 3f. Then, the engaging protrusions 46 on the other end (upper end in this case) of both shorter sides 412 are inserted into the engaging grooves 36. After the cover 4f is slid across the cabinet 3f and the cover 4f is positioned accurately in relation to the cabinet 3f, the cover 4f and the cabinet 3f are fixed to each other.

In the display device F of the present embodiment, the engaging grooves 36 are formed along the shorter sides 312 of the cabinet 3f, and the engaging protrusions 46 are slid inside the engaging grooves 36, and thus, the sliding direction length of the cover 4f is shorter than that of the display device A in which the engaging grooves 32 are formed along the longer sides 311. In this manner, it is possible to shorter the amount of time required for assembly.

The cross-sections of the projections 461 of the engaging protrusions 46 along a plane parallel to the rear surface of the cover 4f are made to have a shape with the same horizontal and vertical dimensions such as a square or circle, and similarly, the retaining portions 462 as seen from the front of the cover 4f are also made to have a shape with the same horizontal and vertical dimensions such as a square or circle. By appropriately adjusting the positions of the engaging protrusions 46, it is possible for the cover 4f to be attached to the cabinet 3, which includes the engaging grooves 32 along the longer sides 311, or to be attached to the cabinet 3f including the engaging grooves 36 extending along the shorter sides 312.

The engaging protrusions 36 are shown to have the same shape as the engaging protrusions 32 used in the display device A, but the shape is not limited thereto, and any shape or structure similar to those shown in the embodiments above may be used. Other characteristics are the same as those of any of the display devices shown in Embodiments 1 to 5.

### OTHER EMBODIMENTS

In the display device of the present invention, the cabinet surrounds the display unit and mitigates the effect of shock from outside the display unit. Thus, it is preferable that the cabinet be made of a strong material. The cabinet can be made of a metal such as aluminum (alloy), stainless steel, or a steel plate.

Meanwhile, in the display device according to the present invention, the engaging grooves provided in the cabinet are slidably engaged with the engaging protrusions of the cover, thereby attaching the cover to the cabinet. In the display device, the display unit and the like emits a lot of heat, and this can cause the cabinet and the cover to become hot. In such a case, if there is a large difference in linear coefficient of thermal expansion between the cabinet and the cover, the difference in thermal expansion therebetween can result in stress (heat stress) concentrating in the engaging protrusions, resulting in damage.

Also, the user can easily come into contact with the cover, and thus, the cover is made not of a metal, which can become hot, but of a resin with a low thermal conductivity. In order to mitigate heat stress acting on the engaging protrusions, the cabinet is also made of the same resin as the cover or of a resin having a similar linear coefficient of thermal expansion. Resins used in the cover can include polycarbonate (PC: linear coefficient of thermal expansion: 7×10⁻⁵ cm/cm·° C.), ABS resin (linear coefficient of thermal expansion: 7×10⁻⁵ cm/cm·° C. to 13×10⁻⁵ cm/cm·° C.), or a polymer alloy of polycarbonate and ABS resin (linear coefficient of thermal expansion: 7×10⁻⁵ cm/cm·° C.), for example. Even if a resin besides these is used, by using resins having the same or similar linear coefficients of thermal expansion for the cover and cabinet, it is possible to mitigate damage from thermal expansion.

In the embodiments above, the engaging grooves are provided in the cabinet and the engaging protrusions are formed in the cover, but it is possible to have the opposite configuration in which the engaging grooves are provided in the cover and the engaging protrusions are provided in the cabinet.

In the embodiments above, a display unit that displays images in the front (such as a liquid crystal display unit or an EL display unit) is used as the display unit, but by using a display unit (light-emitting unit) configured so as to emit planar light (with the in-plane luminous flux density (luminance) preferably being uniform), it is possible to use the display device as an illumination device.

Embodiments of the present invention were described above, but the present invention is not limited to the above embodiments. The present invention can have various modifications without departing from the spirit thereof.

A display device solving the problem of the present invention includes: a first cover member 3 including a first frame region 31 surrounding an edge of a front surface of a display unit; a second cover member 4 disposed on a front surface of the first cover member 3 and including a second frame region 41 overlapping the first frame region 31; an engaging protrusion 42 that protrudes from a rear surface of the second frame region 41; and an engaging groove 32 formed in a surface opposing a front surface of the first frame region 31 where the engaging protrusion 42 projects, the engaging protrusion 42 being able to slide in the engaging groove 32, the second cover member 4 being positioned in relation to the first cover member 3 by inserting the engaging protrusion 42 into an end of the engaging groove 32 and sliding the engaging protrusion 42 in the engaging groove 32.

In this manner, the engaging protrusions 42 and the engaging grooves 32 are formed in a portion where the first cover member 3 and the second cover member 4 overlap, or in other words, where a viewer cannot see, and thus, it is possible to reduce the size of the portion of the display device A outside the display region (the so-called frame region).

In this manner, it is possible to dispose the display device having a large display region in a small space (which improves freedom in selecting where to place the display device), and it is possible to reduce unneeded portions of the frame region, which is effective for reducing the size and weight of the display device.

In a display device that solves the problem of the present invention, the engaging protrusion 42 and the engaging groove 32 respectively have detachment mitigation structures (422, 322) that mitigate detachment of the second cover member 4 from the first cover member 3 by the engaging protrusion 42 being in contact with the engaging groove 32 when a force to cause the second cover member 4 to move away from the first cover member 3 acts thereon.

In this manner, it is possible to mitigate detachment of the second cover member 4 from the first cover member 3 and it is possible to mitigate offsetting of the second cover member 4 when the second cover member 4 is slid.

In a display device that solves the problem of the present invention, the detachment mitigation structures include: a retaining portion 422 disposed on a tip of the engaging protrusion 42 and formed so as to extend in a direction intersecting with a direction in which the engaging protrusion 42 slides; and a retaining groove 322 provided inside the engaging groove 32 and extending in a direction intersecting with a lengthwise direction of the engaging groove 32, the retaining groove 322 being formed in a shape allowing slidable insertion therein of the retaining portion 422 of the engaging protrusion 42.

In this manner, it is possible to mitigate detachment of the second cover member 4 from the first cover member 3 and it is possible to mitigate offsetting of the second cover member 4 when the second cover member 4 is slid.

In a display device that solves the problem of the present invention, the detachment mitigation structures include: an inclined surface 451 provided on the engaging protrusion 45 and inclined in relation to a line normal to a protruding surface of the engaging protrusion 45; and an inclined surface 352 provided in the engaging groove 35 and formed so as to face the inclined surface 452 of the engaging protrusion 45.

In this manner, it is possible to mitigate detachment of the second cover member 4 from the first cover member 3 and it is possible to mitigate offsetting of the second cover member 4 when the second cover member 4 is slid.

In a display device that solves the problem of the present invention, the first frame region 31 and the second frame region 41 are rectangular frames including a pair of longer sides 311 and 411 and a pair of shorter sides 312 and 412, the engaging groove 32 being formed on either the pair of longer sides 311 or the pair of shorter sides 312 of the first frame region 31.

In this manner, the engaging protrusions 42 and the engaging grooves 32 are formed in a portion where the first cover member 3 and the second cover member 4 overlap, or in other words, where a viewer cannot see, and thus, it is possible to reduce the size of the portion of the display device A outside the display region (the so-called frame region).

Also, it is possible to dispose the display device having a large display region in a small space (which improves freedom in selecting where to place the display device), and it is possible to reduce unneeded portions of the frame region, which is effective for reducing the size and weight of the display device.

In a display device that solves the problem of the present invention, the first cover member 3 is a bezel that holds the display unit and the second cover member 5 is a lens cover including a lens portion 50 in side edges thereof.

With such a configuration, the engaging protrusion and the engaging groove are formed in the frame region where the bezel and the lens cover overlap, and thus, even if the lens cover is thin, it is possible to make the frame region not visible. In this manner, it is possible to reduce the thickness and weight of the display device.

### DESCRIPTION OF REFERENCE CHARACTERS

A-F display device
1 display unit
2 chassis
3, 3c, 3d, 3f cabinet
30 opening
31 main body portion
311 longer side
312 shorter side
32, 32c, 32f engaging groove
320 rib
321 opening
322 retaining groove
35 engaging groove
36 engaging groove
4, 4b-4f cover
40 opening
41 main body portion
411 longer side
412 shorter side
42, 42b-42f
46 engaging protrusion
5 cover
50 lens portion
51 attachment portion
511 longer side
512 shorter side
52 engaging protrusion

1. A display device, comprising:
a display unit;
a first cover member including a first frame region that surrounds a periphery of a front surface of the display unit; and
a second cover member disposed on a front surface of the first cover member and including a second frame region that coincides in position with the first frame region;
wherein an engaging protrusion protrudes from one of a front surface of the first frame region or a rear surface of the second frame region,
wherein an engaging groove is formed in another of the front surface of the first frame region or the rear surface of the second frame region to engage the engaging protrusion, the engaging protrusion being configured to be slidable in the engaging groove, and
wherein the engaging protrusion is inserted from an end of the engaging groove and slid inside the engaging groove, thereby positioning the second cover member in relation to the first cover member.

2. The display device according to claim 1, wherein the engaging protrusion and the engaging groove have detachment prevention structures that, when a force in a direction away from the first cover member acts on the second cover member, contact each other to prevent detachment of the second cover member from the first cover member.

3. The display device according to claim 2, wherein the detachment prevention structures include: a retaining portion disposed on a tip of the engaging protrusion and formed so as to extend in a direction intersecting with a direction in which the engaging protrusion slides; and a retaining groove provided inside the engaging groove and extending in a direction intersecting with a lengthwise direction of the engaging groove, the retaining groove being formed in a shape allowing slidable insertion therein of the retaining portion of the engaging protrusion.

4. The display device according to claim 1,
wherein the first frame region and the second frame region are rectangular frames including a pair of longer sides and a pair of shorter sides, and
wherein the engaging groove is formed in either the pair of longer sides or the pair of shorter sides of the first frame region or the second frame region.

5. The display device according to claim 1, wherein the first cover member is a bezel for holding in place the display unit, and the second cover member is a lens cover including a lens portion in side edges of the second cover member.
